SEQUENCE LISTING (55 sequences)

SEQ ID NO: 1 - protein, 10 aa, Artificial Sequence
  Synthetic
LGGGGGGDFR

SEQ ID NO: 2 - protein, 9 aa, Artificial Sequence
  Synthetic
LLGGGGDFR

SEQ ID NO: 3 - protein, 8 aa, Artificial Sequence
  Synthetic
LLLGGDFR

SEQ ID NO: 4 - protein, 7 aa, Artificial Sequence
  Synthetic
LLLLDFR

SEQ ID NO: 5 - protein, 8 aa, Artificial Sequence
  Synthetic
LLLLLDFR

SEQ ID NO: 6 - protein, 18 aa, Homo sapiens
MADEAGSEADHEGTHSTK

SEQ ID NO: 7 - protein, 9 aa, Homo sapiens
TVIGPDGHK

SEQ ID NO: 8 - protein, 9 aa, Homo sapiens
GDFSSANNR

SEQ ID NO: 9 - protein, 16 aa, Homo sapiens
GGSTSYGTGSETESPR

SEQ ID NO: 10 - protein, 8 aa, Homo sapiens
DCQDIANK

SEQ ID NO: 11 - protein, 15 aa, Homo sapiens
LTIGEGQQHHLGGAK

SEQ ID NO: 12 - protein, 13 aa, Homo sapiens
LGVRPSQGGEAPR

SEQ ID NO: 13 - protein, 8 aa, Homo sapiens
ISCTIANR

SEQ ID NO: 14 - protein, 13 aa, Homo sapiens
TCVADESAENCDK

SEQ ID NO: 15 - protein, 13 aa, Homo sapiens
CCAAADPHECYAK

SEQ ID NO: 16 - protein, 10 aa, Homo sapiens
ECCEKPLLEK

SEQ ID NO: 17 - protein, 9 aa, Homo sapiens
WCALSHHER

SEQ ID NO: 18 - protein, 11 aa, Homo sapiens
WCAVSEHEATK

SEQ ID NO: 19 - protein, 16 aa, Homo sapiens
EGTCPEAPTDECKPVK

SEQ ID NO: 20 - protein, 9 aa, Homo sapiens
VPSHAVVAR

SEQ ID NO: 21 - protein, 6 aa, Homo sapiens
DCHLAR

SEQ ID NO: 22 - protein, 9 aa, Homo sapiens
QVLLHQQAK

SEQ ID NO: 23 - protein, 8 aa, Homo sapiens
GPPVSCIK

SEQ ID NO: 24 - protein, 13 aa, Homo sapiens
LQSIGTENTEENR

SEQ ID NO: 25 - protein, 11 aa, Homo sapiens
ALANSLACQGK

SEQ ID NO: 26 - protein, 10 aa, Homo sapiens
DGGAWGTEQR

SEQ ID NO: 27 - protein, 15 aa, Homo sapiens
FNAHGDANTIVCNSK

SEQ ID NO: 28 - protein, 12 aa, Homo sapiens
VGGTSDVEVNEK

SEQ ID NO: 29 - protein, 8 aa, Homo sapiens
VGEVIVTK

SEQ ID NO: 30 - protein, 12 aa, Homo sapiens
NMSVIAHVDHGK

SEQ ID NO: 31 - protein, 8 aa, Homo sapiens
SDPVVSYR

SEQ ID NO: 32 - protein, 9 aa, Homo sapiens
EATTNAPFR

SEQ ID NO: 33 - protein, 10 aa, Homo sapiens
ADLSGMSGAR

SEQ ID NO: 34 - protein, 14 aa, Homo sapiens
AVTEQGHELSNEER

SEQ ID NO: 35 - protein, 11 aa, Homo sapiens
YLSEVASGDNK

SEQ ID NO: 36 - protein, 10 aa, Homo sapiens
IAVAAQNCYK

SEQ ID NO: 37 - protein, 12 aa, Homo sapiens
SNVSDAVAQSTR

SEQ ID NO: 38 - protein, 12 aa, Homo sapiens
HLIPAANTGESK

SEQ ID NO: 39 - protein, 8 aa, Homo sapiens
IISSIEQK

SEQ ID NO: 40 - protein, 10 aa, Homo sapiens
STTTGHLIYK

SEQ ID NO: 41 - protein, 11 aa, Homo sapiens
MDSTEPPYSQK

SEQ ID NO: 42 - protein, 7 aa, Homo sapiens
EVSTYIK

SEQ ID NO: 43 - protein, 9 aa, Homo sapiens
TAVCDIPPR

SEQ ID NO: 44 - protein, 9 aa, Homo sapiens
NMMAACDPR

SEQ ID NO: 45 - protein, 12 aa, Homo sapiens
VLANPGNSQVAR

SEQ ID NO: 46 - protein, 16 aa, Homo sapiens
LLETTDRPDGHQNNLR

SEQ ID NO: 47 - protein, 9 aa, Homo sapiens
LVIITAGAR

SEQ ID NO: 48 - protein, 8 aa, Homo sapiens
FIIPNVVK

SEQ ID NO: 49 - protein, 14 aa, Homo sapiens
LESEEEGVPSTAIR

SEQ ID NO: 50 - protein, 11 aa, Homo sapiens
IGEGTYGVVYK

SEQ ID NO: 51 - protein, 10 aa, Homo sapiens
HTLNQIDSVK

SEQ ID NO: 52 - protein, 17 aa, Homo sapiens
QQTQHAVEGDCDIHVLK

SEQ ID NO: 53 - protein, 15 aa, Homo sapiens
TPIVGQPSIPGGPVR

SEQ ID NO: 54 - protein, 13 aa, Homo sapiens
WTAVVVPSGEEQR

SEQ ID NO: 55 - protein, 14 aa, Homo sapiens
SWTAADTAAQISQR

(19) United States
(12) Patent Application Publication
(10) Pub. No.: US 2013/0090862 A1
(43) Pub. Date: Apr. 11, 2013

(54) METHODS AND SYSTEMS FOR ANALYSIS OF PEPTIDE SAMPLE STREAMS USING TANDEM MASS SPECTROSCOPY

(71) Applicants: Oleg V. Krokhin, Winnipeg (CA); Vic Spicer, Winnipeg (CA)

(72) Inventors: Oleg V. Krokhin, Winnipeg (CA); Vic Spicer, Winnipeg (CA)

(73) Assignee: UNIVERSITY OF MANITOBA, Winnipeg, MB (CA)

(21) Appl. No.: 13/697,971

(22) PCT Filed: May 20, 2011
(86) PCT No.: PCT/CA2011/000586

§ 371 Date: Nov. 14, 2012

Related U.S. Application Data
(60) Provisional application No. 61/346,678, filed on May 20, 2010.

(51) Int. Cl. H01J 49/00; G01N 30/72

(52) U.S. Cl. CPC H01J 49/0036; G01N 30/72
USPC 702/21; 250/282

(57) ABSTRACT

The present disclosure relates to methods and systems for analyzing a peptide sample stream from a chromatography column using tandem mass spectroscopy. Analysis of the sample stream during a first time interval is performed in order to identify peptides, such as tryptic peptides, that are contained in the sample stream. Database searching is then performed to identify one or more protein sequences that contain the identified peptide sequence and to identify associated peptide sequences that are contained in the protein sequence that differ from the peptide sequence. The retention time of associated peptides is estimated based on the hydrophobicity of the predicted peptides and by spiking the sample with standard peptides. Information on associated peptides can then be used to configure the mass spectrometer during a second time interval to detect or ignore ions that correspond to the associated peptides.

### RELATED APPLICATIONS

This application claims the benefit of U.S. Provisional Patent Application Ser. No. 61/346,678 filed May 20, 2010, the entire contents of which are hereby incorporated by reference herein for all purposes.

### FIELD OF THE INVENTION

The present disclosure relates to methods and systems for the analysis of sample streams using mass spectroscopy, and more specifically to methods and systems for the analysis of chromatographic sample streams in tandem mass spectroscopy.

### BACKGROUND OF THE INVENTION

The field of proteomics has followed on the development of two soft ionization techniques in the late 1980's: matrix assisted laser desorption ionization (M. Karas, F. Hillenkamp, Analytical Chemistry 1988 60:2299-301) and electrospray ionization (J. B. Fenn, M. Mann, S. F. Wong and C. M Whitehouse, Science 1989 246:64-71). Mass spectrometry based analysis of biological compounds (peptides and proteins) is now commonplace.

Protein samples are typically subjected to proteolytic digestion to reduce them to manageably sized peptides. Mixtures of a few proteins can be analyzed using simple mass spectrometers; the proteins can be identified by the masses of multiple member peptides known as peptide mass fingerprinting. In more sophisticated instruments, parent peptide ions can subsequently be (individually) subjected to collision induced dissociation (CID) inside the mass spectrometer, breaking them into fragments along amino acid bond points. The resulting tandem (MS/MS) mass spectrum often contains sufficient information to deduce a peptide's amino acid sequence from the differences between the masses of the fragment ions.

The growing complexity of biological samples has rapidly run up against the limitations of mass spectrometry to resolve all components in these mixtures. There are mechanisms for reducing complex samples into sub components. The most common of these are gel electrophoresis and reversed-phase high performance liquid chromatography (HPLC).

The online coupling of HPLC to MS (MS/MS) via electrospray ionization is an important tool for high-throughput proteomics and systems biology, but presents some practical limitations. The mass spectrometer system acquires data in real-time with the HPLC separation process; the instrument has limited time to select parents and perform CID on these parents. Under current methodologies, only the most intense parents from a given MS spectrum are chosen for MS/MS, but typically <50% of these spectra yield high-confidence peptides.

One approach to improve observed peptide coverage is to perform two identical instrument runs on the same sample. The peptide sequence results from the first run can be used to pre-select or exclude parent MS entries in the second run in a hypothesis driven analysis. This is time consuming and may prove impractical if the sample quantity is limited.

An alternative is to identify peptides in almost real-time, making subsequent parent selection (or exclusion) based on information from what has been already identified.

Overney and Roark (U.S. Pat. No. 7,498,568) describe a mass spectroscopy system comprising a controller wherein the controller directs the mass spectrometer to collect a product ion spectrum based on the analysis of a precursor ion spectrum in real time according to whether the precursor spectra satisfies predetermined evaluation criterion.

Wu et al. (RT-PSM, a real-time program for peptide-spectrum matching with statistical significance Rapid Commun. Mass Spectrom. 2006; 20(8):1199-208) describe an algorithm for real-time peptide identification with the aim of implementing real-time control of tandem mass spectrometry data acquisition. Wu et al. do not describe the prediction of chromatographic retention times for placing peptides on an exclusion list for the real-time control of tandem mass spectrometry data acquisition.

There remains a need for novel methods and systems for the analysis of complex biological samples using chromatography coupled to mass spectroscopy.

### SUMMARY OF THE INVENTION

In one aspect, the present disclosure provides methods and systems for analyzing a sample comprising peptides using chromatography and tandem mass spectroscopy. The disclosure also provides methods and systems for the analysis of mass spectra of peptide sample streams generated using liquid chromatography and tandem mass spectroscopy.

In one aspect, peptides in a chromatographic sample stream are analyzed during a first time interval to predict the presence of associated peptides in the sample stream during a second time interval. In one aspect, retention times are predicted for associated peptide sequences. The sample is optionally spiked with standard peptides and predicted retention times for associated peptide sequences are determined. In one embodiment, predicted retention times are determined based on calculated hydrophobicity index values for each associated peptide sequence and the observed retention times and known properties of the standard peptides. The mass spectrometer may be configured to selectively transmit or impede ions or select parent ions for dissociation that correspond to the associated peptides in the second time interval.

In one aspect, information regarding associated peptide sequences can be used to configure the mass spectrometer during a second time interval to optimize the collection of mass spectrometer data for a sample stream. In one embodiment, the mass spectrometer can be configured to select parent ions in a second time interval that are more likely to be informative for identifying the peptides and/or proteins contained in the sample stream rather than selecting parent ions based on ion intensity. In one embodiment, the mass spectrometer can be configured to ignore or filter out primary ions that are predicted to belong to proteins that have already been identified with a high degree of certainty based on the analysis of sample peptides in a first or earlier time interval.

Accordingly, in one embodiment there is provided a method for analyzing a sample using chromatography and tandem mass spectrometry comprising:
a) providing a sample comprising one or more sample peptides,
b) adding one or more standard peptides to the sample to form a test sample, wherein an amino acid sequence and hydrophobicity index for each standard peptide is known,
c) introducing the test sample into a chromatography column and eluting a test sample stream from the chromatography column into a tandem mass spectrometer,
d) acquiring first time interval mass spectra and associated retention times for a plurality of peptides contained in the test sample stream during a first time interval, wherein the test sample stream during the first time interval comprises at least one standard peptide,
e) comparing the first time interval mass spectra to a mass spectra reference database to form a set of identified sample peptide sequences based on sample peptides contained in the sample stream during the first time interval,
f) for at least one identified sample peptide sequence, searching a protein sequence reference database to identify and retrieve one or more protein sequences that contain the identified sample peptide sequence,
g) generating a set of associated peptide sequences by analyzing the one or more protein sequences retrieved in step f) to identify one or more associated peptide sequences, wherein the identified sample peptide sequence and the associated peptide sequence differ and are both contained within the protein sequence,
h) determining a predicted retention time for at least one associated peptide sequence based on the retention time for one or more standard peptides acquired in step d), and
i) acquiring second time interval mass spectra and associated retention times for the test sample stream during a second time interval by configuring the tandem mass spectrometer to transmit some ions and filter out other ions based on the at least one associated peptide sequence in the set of associated peptide sequences and the predicted retention time determined in step h).

In one embodiment, a set of associated peptide sequences and predicted retention times are determined more than once during the elution of a sample and the tandem mass spectrometer is further configured to acquire mass spectra during a further second time interval. In one embodiment steps d) to i) set out above can be repeated more than once during the elution of a test sample stream from a chromatography column. In one embodiment, the chromatography column is a reverse phase high performance liquid chromatography (RP-HPLC) column. In one embodiment, the method uses RP-HPLC-ESI-MS/MS.

In one embodiment, a plurality of standard peptides is added to the sample to form the test sample. In one embodiment, the predicted retention time for the at least one associated peptide sequence is determined based on a plurality of retention times for the plurality of standard peptides.

In one embodiment, during the first time interval mass spectra are acquired by selecting parent ions for dissociation into secondary ions based on an observed intensity of the parent ions. In one embodiment, during a second time interval mass spectra are acquired by selecting parent ions for dissociation into secondary ions based on a set of associated peptide sequences and retention times generated by analyzing mass spectra from the first time interval.

In one embodiment, the tandem mass spectrometer comprises a mass analyzer and a detector and in the second time interval the mass analyzer is configured to either transmit or impede the transmission of an ion or secondary ion of an associated peptide sequence to the detector based on one or more characteristics of the associated peptide sequence such as retention time or m/Z.

In one embodiment, an associated peptide sequence contained in the set of associated peptides is selected or excluded as a parent ion for dissociation into secondary ions.

In one embodiment, the method comprises calculating a retention times for a plurality of associated peptide sequences. In one embodiment, information on the retention times for associated peptide sequences is used to configure the mass spectrometer to transmit some ions and filter out other ions.

In one embodiment, the retention time for an associated peptide sequence is calculated based on the hydrophobicity index (HI) for that associated peptide sequence. In one embodiment, a hydrophobicity index is calculated for an associated peptide sequence based on the peptide sequence as known in the art. The retention time for an associated peptide may be calculated based on the observed retention times and known hydrophobicity indices for the standard peptides. The standard peptides are useful for characterizing the operational characteristics of the chromatography column from which the sample stream is eluted. In one embodiment, the operational characteristics include T₀, and/or characteristics related to linear solvent slope theory. In one embodiment, the standard peptides comprise one or more peptides selected from the group consisting of LGGGGGGDFR (SEQ ID NO: 1), LLGGGGDFR (SEQ ID NO: 2), LLLGGDFR (SEQ ID NO: 3), LLLLDFR (SEQ ID NO: 4), and LLLLLDFR (SEQ ID NO: 5).

Optionally, the hydrophobicity index for an associated peptide sequence is calculated using methods known in the art such as SSRCalc as described in Krokhin et al. Molecular and Cellular Proteomics 2004 September; 3(9):908-19; Krokhin Anal. Chem., 2006, 78 (22), pp 7785-7795; and Spicer et al. Anal. Chem., 2007, 79 (22), pp 8762-8768, all hereby incorporated by reference. In one embodiment, the retention times for each associated peptide is calculated according to the equation:

T_{P}=HI_{P}/(gradient slope)+T₀

wherein T_{P} is the retention time for the peptide, HI_{P} is the hydrophobicity index for the peptide, and T₀ is calculated based on an observed retention time of one or more standard peptides. In one embodiment, T₀ is a reference “start time” for peptide elution, and is measured for each experimental run. In one embodiment, the gradient slope is a known operating parameter for the elution of the sample from the chromatography column in gradient elution liquid chromatography.

In another embodiment, the method further comprises calculating a mass (m) and/or electrospray ion charge state (Z) for each of the associated peptide sequences. The mass spectrometer can then be configured to transmit some ions and filter out other ions based on the mass and/or electrospray charge state of at least one associated peptide sequence in the set of associated peptide sequences. In one embodiment, the mass spectrometer is configured to transmit some ions and filter out other ions based on the calculated retention time of an associated peptide sequence. Optionally, the electrospray ion charge state (Z) for each associated peptide sequence can be calculated by summing the number of basic amino acids (K, R and H) in the associated peptide sequence.

In one embodiment, the samples analyzed by the methods described herein originally contained proteins that have been fragmented into smaller peptides. In one embodiment, the proteins have been fragmented into peptides by exposure to the enzyme trypsin or another sequence specific protease. In one embodiment, the sample peptides are tryptic peptides and a set of associated peptide sequences is generated by analyzing the protein sequence to identify associated peptide sequences that represent tryptic peptides. A person of skill in the art will appreciate that tryptic peptides can readily be predicted by identifying tryptic cleavage sites in the sequence of a protein as known in the art. In one embodiment, the tryptic peptides can have 0, 1, 2 or 3 missed tryptic cleavages.

In one embodiment, associated peptide sequences are identified that contain one or more post-translational modifications. For example, associated peptide sequences can include one or more post-translation modifications such as N-terminal cyclization, deamidation or methionine oxidation. Accordingly, a set of associated peptide sequences may include peptides that differ only in the presence of a post-translational modification. In one embodiment, associated peptide sequences may differ in glycosylation or phosphorylation.

In a further aspect, the present disclosure provides a computerized control system for controlling and receiving data from a tandem mass spectrometer. In one embodiment, the computerized control system comprises at least one processor and memory configured to provide:
a) a control and communications module for receiving data from the tandem mass spectrometer, the data comprising a first set of mass spectra and associated retention times collected during a first time interval for a sample stream comprising one or more sample peptides and one or more standard peptides, wherein an amino acid sequence and hydrophobicity index for each standard peptide is known;
b) a search module for:
   i) identifying amino acid sequences for the one or more sample peptides contained in the sample stream by comparing the first set of mass spectra to a mass spectra reference database to form a set of identified sample peptide sequences, and
   ii) for at least one identified sample peptide sequence, search a protein sequence reference database to identify and retrieve one or more protein sequences that contain the identified sample peptide sequence; and
c) an analysis module for receiving the one or more protein sequences identified by the search module and generating a set of associated peptide sequences by analyzing the one or more protein sequences to identify one or more associated peptide sequences, wherein the identified sample peptide sequence and the associated peptide sequence are both contained within the protein sequence and the analysis module being further operable to determine a predicted retention time for at least one associated peptide sequence based on the retention times for the one or more standard peptides.

In one embodiment, the control and communications module is further operable to communicate with and configure the tandem mass spectrometer to transmit some ions and filter out other ions based on at least one associated peptide sequence in the set of associated peptide sequences and the predicted retention time.

In one embodiment, the control and communications module is further operable to communicate with and configure the tandem mass spectrometer to select or exclude one or more associated peptides contained in the set of associated peptide sequences as parent ions for dissociation into secondary ions. In one embodiment, the control and communications module is operable to configure the operational parameters of the mass spectrometer.

In one embodiment, the computerized control system further comprises a user interface operable to receive one or more selection criteria, wherein the processor is further operable to configure the analysis module to include associated peptide sequences in the set of associated peptide sequences based on the criteria received in the user interface. Examples of selection criteria include criteria for selecting peptides that contain specific sequence features or are known to be from a specific protein or protein family. Other examples of selection criteria include retention time, parent ion intensity, mass (m) and charge (Z). Selection criteria may also include inclusion or exclusion lists of known peptides.

In one embodiment the analysis module is configured to determine a predicted retention time for at least one associated peptide sequence based on the retention times for one or more standard peptides and a hydrophobicity index for the at least one associated peptide sequence.

In one embodiment, the analysis module is further operable to determine the predicted retention time for at least one associated peptide sequence based on the retention times for a plurality of standard peptides.

In one embodiment, the system comprises a tandem mass spectrometer comprising a first mass analyzer operable to select a parent ion, a collision cell operable to dissociate a parent ion to produce one or more secondary ions, a second mass analyzer operable to select a secondary ion, and a detector. In one embodiment, the mass spectrometer comprises an ionization source for ionizing molecules in the sample stream. In one embodiment, the detector is operable to detect the abundance, or relative abundance of ions in the sample stream. In one embodiment, the time when the sample is first introduced into the chromatography column is recorded, and the detector is configured to detect the retention time of molecules in the sample stream.

In another embodiment, the system comprises a chromatography column, wherein the tandem mass spectrometer is adapted to receive a sample stream comprising one or more sample peptides from the chromatography column. In one embodiment the chromatography column is a reverse-phase HPLC chromatography column.

Additional embodiments include programmable media containing instructions for analyzing a tandem mass spectroscopy data and/or controlling a tandem mass spectrometer according to the methods described herein.

Further aspects and advantages of the embodiments described herein will appear from the following description taken together with the accompanying drawings.

### BRIEF DESCRIPTION OF THE DRAWINGS

The disclosure will now be described in greater detail with reference to the drawings in which:

FIG. 1 is a schematic showing a HPLC-ESI-TOF MS (MS/MS) system according to one embodiment of the invention.

FIG. 2 shows Total Ion Current Spectrum of a 2-hour HPLC-ESI-TOF sample at 0.375% per minute gradient, showing the time regions (R0, R1, R2 and R3) defined by the elution of standard peptides P2-P5.

FIG. 3 is a schematic showing an operational workflow of semi real-time data acquisition according to one embodiment of the invention.

FIG. 4 shows a mass spectra for potential Q14974 peptide [MELITILEK +2]; predicted to elute at 56.9 minutes; (low intensity) MS spectrum observed at 59.2 minutes as described in Example 4.

FIG. 5 shows a plot of Hydophobic Index (HI) and Retention Time (RT) for peptides in the Whole Cell Lysate (WCL) sample described in Example 5. The GPU peptide ID engine reports peptide sequences not seen by GPM but that still have reasonable HI vs RT correlations, further supporting their identification validity.

FIG. 6 is a pie chart showing peptide search results for the WCL sample as described in Example 5; 85% agreement with GPM or Mascot results; 11% of the GPM results missed; 3% potential false identifications.

FIG. 7 is a schematic diagram illustrating one embodiment of a computerized control system for controlling and receiving data from a mass spectrometer.

### DETAILED DESCRIPTION OF THE INVENTION

### Definitions

As used herein, the term “sample” refers to any sample containing or thought to contain one or more peptides. The term “sample” also includes samples containing proteins that have been treated with trypsin to produce tryptic peptides.

As used herein, “sample stream” refers to a continuous flow of sample and eluent that exits a chromatography column.

As used herein the term “peptide” refers to two or more amino acids linked by a peptide bond, and includes synthetic and natural peptides as well as peptides that are modified.

As used herein, a “protein” refers to a plurality of amino acids linked by peptide bonds that have been observed in nature or found in a protein sequence reference database. Typically, a “protein” may be fragmented into a plurality of shorter “peptides”.

As used herein, “standard peptide” refers to a peptide for which the amino acid sequence and hydrophobicity index of the peptide are known. Standard peptides are used to experimentally determine the operating characteristics of a chromatography column.

As user herein the term “retention time” refers to the time elapsed from when a sample is first introduced into a chromatography column until the peptide is detected by a detector after eluting from the chromatography column.

As used herein a “mass spectra reference database” refers to a database that contains mass spectra data associated with specific peptide sequences. A “protein sequence reference database” refers to database that contains sequence information and associated identifiers for a plurality of proteins. Examples of protein sequence reference databases include Swiss-Prot and UniProt, as known in the art. A reference database may be accessed by submitting queries using the Internet or across a computer network, or it may be created or downloaded for local use on a computer or computer system.

As used herein, “parent ion” or “precursor ion” refers to a ion generated by ionizing a molecule in the sample stream that is then selected for fragmentation into a “secondary ion” or “product ion’.

As used herein, a “secondary ion” or “product ion” refers to an ion that is generated through the dissociation of a parent ion. In one embodiment, the secondary ions are produced by Collision Induced Dissociation (CID) of parent ions, or by other methods of producing ions such as matrix assisted laser desorption (MALDI), or electrospray ionization (ESI) as known in the art.

As used herein, the terms “configuring” or “configuring a mass spectrometer” refers to changing the operational parameters of a mass spectrometer to help ionize, select, dissociate or detect an ion. For example, configuring a mass spectrometer may include controlling the parameters of a mass analyzer to select for ions or a certain mass to charge (m/Z) ratio.

In one embodiment of the present description, tandem mass spectra for a sample stream containing peptides are analyzed for a first time interval to identify the sequences of peptides in the sample. The sequences of peptide fragments in the sample stream are determined based on the observed tandem mass spectra by methods known in the art, such as peptide mass fingerprinting and searching mass spectra reference databases.

In one embodiment, database searches are performed to identify protein sequences that contain the sequence of identified peptide fragments. The resulting protein sequences are then analyzed to identify the sequence of any associated peptides that are contained in the protein sequence that differ from the sequence of the peptide fragment that has already been identified. For example, if the sample stream contains tryptic peptides the protein sequences can be analyzed to determine the likely sequences of any additional tryptic peptide fragments. Many of the associated peptides will not have been eluted in the sample stream and detected during the first time interval and represent predicted “future” peptides that may elute in the sample stream during a second (later) time interval.

In one embodiment, the reference databases are restricted based on taxonomy, or other known characteristics of the sample such as species identity.

In one embodiment, information on associated peptides can be used to configure the tandem mass spectrometer in a second time interval in order to detect or filter a set of associated peptide ions. For example, associated peptides can be selected or excluded as precursor ions for dissociation into secondary ions by the tandem mass spectrometer. Information on associated peptides may be used to supplant or supplement intensity-based selection of parent ions during tandem mass spectroscopy. This allows for the selection and analysis of parent ions that are of interest but otherwise may be too weak merit parent selection in an intensity driven spectra acquisition mode.

In one aspect, the predicted retention times for associated peptide sequences are determined and used to help configure the tandem mass spectrometer in a second time interval. As described herein, the predicted retention times for associated peptides can be determined based on calculated hydrophobicity index (HI) values for the associated peptide sequences and the operating characteristics of the chromatography column producing the sample stream. In one embodiment, the operating characteristics of the chromatography column are determined by spiking the sample with a set of standard peptides and detecting the retention time of one or more standard peptides.

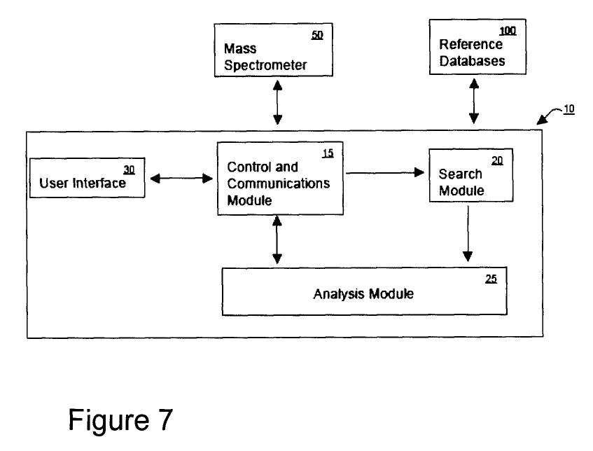

In one aspect, there is provided a computerized control system configured to control and receive data from a tandem mass spectrometer. One embodiment of a computerized control system is shown in FIG. 7.

Turning to FIG. 7, the computerized control system (10) comprises a control and communications module (15), a search module (20), an analysis module (25) and a user interface (30). The control and communications module is operable to receive data comprising mass spectra and retention times from a mass spectrometer (50). A search module (20) is operable to identify amino acid sequences for one or more sample peptides contained in the sample stream by comparing the observed mass spectra to a mass spectra reference database (100) to form a set of identified sample peptide sequences. The search module (20) is operable to search a protein sequence reference database (100) to identify and retrieve one or more protein sequences that contain the identified sample peptide sequence.

The analysis module (25) is operable to receive one or more protein sequences identified by the search module (20). In one embodiment, the analysis module (25) is operable to receive data comprising the retention times of one or more standard peptides in the sample stream. The analysis module (20) is operable to generate a set of associated peptide sequences by analyzing one or more protein sequences to identify peptide sequences contained within the protein sequence that differ from the identified sample peptide sequence. The analysis module (25) is also operable to determine a predicted retention time for at least one associated peptide sequence based on the retention times for one or more standard peptides and characteristics of the associated peptide sequence such as hydrophobicity. Optionally, the associated peptide sequences are tryptic peptides and the analysis module is configured to predict tryptic peptides generated by the tryptic digestion of the protein sequence.

In one embodiment, criteria for selecting an associated peptide sequence for inclusion in a set of associated peptide sequences is specified by a user via the user interface (30). The analysis module (25) is operable to calculate a hydrophobicity index and/or retention time for one or more associated peptide sequences. Optionally, the analysis module is operable to calculate a mass, and/or electrospray ion charge state for one or more associated peptide sequences.

A user may specify criteria or parameters for searching the reference databases (100) via the user interface (30). For example, the user may select a restricted set of databases for searching by the search module (100) based on a known taxonomy or species for the sample.

The control and communications module (15) is operable to communicate with and configure a mass spectrometer (50). The mass spectrometer may be configured based on the set of associated peptide sequences generated by the analysis module (25). For example, the control and communications module (15) can configure the mass spectrometer (50) to transmit some ions and filter out other ions based on at least one associated peptide in the set of associated peptides.

In one embodiment, there is provided a system and method for tandem mass spectrometry data acquisition by selecting the parent precursor ions in a sample stream to dissociate into product ions. In one embodiment, this is accomplished by a combination of peptide sequence determination using parallel searches against restricted databases for mass spectra collected in a first time interval and the prediction of mass, charge, and hydrophobicity values and/or predicted retention times for “future” associated peptides based on peptides that have been earlier identified. The resulting data can be used to form lists or sets of peptides of interest, or to configure a tandem mass spectrometer to help detect or ignore ions of corresponding associated peptides in a second time interval. In one embodiment, the retention times of associated peptides are determined and used to configure the mass spectrometry to acquire data on peptides of interest.

In one embodiment, the methods and systems described herein operate to allow the fast identification of peptides using a parallel search algorithm. In one embodiment, the methods and systems described herein use methods to accurately predict the chromatographic retention time of peptides as described in Krokhin et al. Molecular and Cellular Proteomics 2004 September; 3(9):908-19; Krokhin Anal. Chem., 2006, 78 (22), pp 7785-7795; and Spicer et al. Anal. Chem., 2007, 79 (22), pp 8762-8768, all hereby incorporated by reference.

The present disclosure provides a method for analyzing tandem mass spectra data in a first time interval that allows the operational parameters of a tandem mass spectrometer to be controlled in a second time interval, such as for controlling the selection of parent ions for dissociation. The applicants have designed and simulation-tested a software system that can perform this operation in a few seconds per cycle. In one embodiment, the analysis occurs at equally spaced intervals through the chromatographic separation and informs the operational parameters of the tandem mass spectrometer during a subsequent time interval. In one embodiment, the sample is spiked with standard calibration peptides that serve a dual function: as trip points for the analysis process, and for calibration to determine the operating characteristics of the chromatography column. The identification and forward prediction analysis may be executed once, or may be executed more than once i.e. 4 or 5 times during an experimental run (typically 1-3 hours).

In one embodiment, the methods described herein are useful for identifying associated peptides that have not yet eluted in a sample stream for inclusion or exclusion as parent ions during tandem mass spectroscopy of the sample stream.

For example, in one embodiment the methods and systems described herein are useful for selecting associated peptides as parent ions such as for Isobaric Tag for Relative and Absolute Quantitation (ITRAQ)-based quantitation experiments where maximum peptide coverage of the member proteins hardens the ratio scoring. The methods and systems are also useful for pursuing post-translational modifications (PTMs) that may have parent intensities too weak to merit MS/MS in the intensity driven acquisition mode (See for example Schmidt et. al, Molecular & Cellular Proteomics, 2008 7:2138-2150). In one embodiment, associated peptides that contain PTMs are identified based on biochemical data regarding known PTMs for a particular protein or peptide.

In another embodiment, the methods and systems described herein are useful for excluding associated peptides as parent ions during tandem mass spectroscopy. For example, common contaminants (such as keratins) may be identified and keratin associated peptides then excluded from selection as parent ions. In one embodiment, the methods and systems can be used to exclude peptides from highly abundant proteins such as RuBisCO in plants, and albumin and IgG in plasma from mammals. The operational parameters of the tandem mass spectrometer may then be controlled to allow for the selection and detection of less abundant, but potentially more interesting, parent ions.

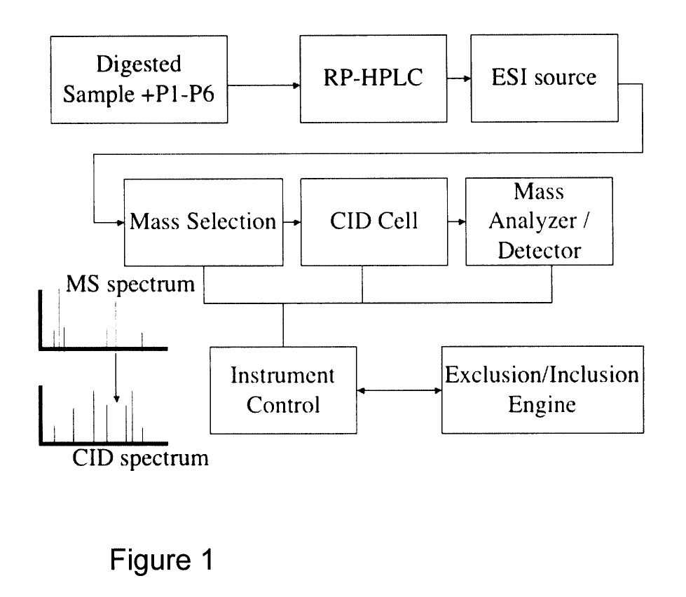

FIG. 1 shows one embodiment of a system for performing the methods described herein. Turning to FIG. 1, a test sample comprising tryptic digested peptides and a set of standard peptides with well characterized chromatographic separation and mass spectrometry properties (P1-P6) is introduced into a reverse phase chromatography (RP-HPLC) column. The sample stream eluting from the column is then ionized by electrospray ionization (ESI), before being introduced into a tandem mass spectrometer capable of producing both primary and secondary ions. Optionally, the tandem mass spectrometer comprises a first mass analyzer for mass selection, a cell for collision induced dissociation (CID) of selected parent ions, and a Mass Analyzer/Detector for selecting and detecting secondary ions produced in the CID cell. As shown in FIG. 1, the mass spectrometer can be configured by an instrument control module, which is in communication with an exclusion/inclusion engine. In one embodiment, the instrument control module and exclusion/inclusion engine is a computerized control system for controlling and receiving data from the tandem mass spectrometer.

In one embodiment during a first time interval the instrument collects mass spectra in MS mode, where the mass selection and CID segments pass essentially all of the ions. After some time, the most intense ions in an accumulated MS spectrum are selected as parents. The instrument toggles into MS/MS mode; the mass selection segment individually chooses the parent ions to dissociate, and the CID segment's operational parameters are set for optimum fragmentation of each parent. The fragment spectra are collected. The instrument then toggles back into MS mode. This toggling between modes can be automated, and may occur every few seconds.

In one aspect of the present disclosure, the mass spectra collected during this first time interval can, concurrent with the instrument's data acquisition, be analyzed to identify associated peptide sequences and inform the operational control of the tandem mass spectrometer during a second time interval. In one embodiment, the analysis comprises the following steps:
1) Peptide sequences for secondary ion spectra collected inside the first elapsed-time interval are identified using a database search. The observed MS/MS fragment ions are compared against the hypothetical ion patterns from database peptides. This first pass uses a modest collection of non-redundant zero missed cleavage tryptic peptides with taxonomy restrictions, containing typically <2 million members.
2) Optionally, the retention times for the identified peptide sequences are predicted and compared to the observed retention times to further validate the identification of peptide sequences.
3) The identified peptide sequences are used to search protein sequence databases for protein sequences that contain the identified peptide sequences. Associated peptide sequences are then identified by analyzing the protein sequences for additional peptides contained within the protein sequence that differ from the identified peptide sequence. For example, if the sample contains tryptic peptides, the associated peptide sequences are identified by detecting tryptic peptides in the protein sequence that differ from the peptide sequences already identified. Associated peptide sequences that contain post-translational modifications (PTMs) can also be identified based on biochemical data of known PTMs or databases of PTMs associated with particular peptides or proteins.
4) The retention times for the associated peptides are then determined based on their calculated hydrophobicity index values. Hydrophobicity values are optionally calculated for an associated peptide sequence using SSRCalculator as described in Krokhin et al. Molecular and Cellular Proteomics 2004 September; 3(9):908-19; Krokhin Anal. Chem., 2006, 78 (22), pp 7785-7795; and Spicer et al. Anal. Chem., 2007, 79 (22), pp 8762-8768, all hereby incorporated by reference. Optionally, the impact of changing the experimental HPLC gradient slope can also be incorporated into the predicted retention time, based on the calculation of peptide Linear Solvent Strength Theory slope values as described in Spicer et al. Predicting Retention Time Shifts Associated with Variation of the Gradient Slope in Peptide RP-HPLC Anal. Chem., 2010, 82 (23), pp 9678-9685, hereby incorporated by reference.
5) Optionally, the electrospray charge state (Z) and/or mass (m) of the associated peptide ions is calculated based on the associated peptide sequences.
6) A set of associated peptide sequences is then generated. The operational parameters of the tandem mass spectrometer may then be adjusted in order to pursue or ignore peaks corresponding to the set of associated peptides during a second time interval following the first time interval. The instrument continues with toggling between MS and MS/MS modes, but with this additional information either supplementing or supplanting the intensity-based parent selection used in the first time interval. Optionally, when the next standard peptide Pn is detected in the MS spectrum, the analysis returns to step (1).

In one embodiment, the analysis can be performed using parallel data-segmented identifications, for example distributed over 7 CPPU cores and 14 threads. In one embodiment, the analysis can be performed by a sequential set of single-spectrum identifications using sparse matrix-vector operations in a group of highly parallel computations. Typically this approach utilizes the large quantity of graphic processor units (GPUs) found on high performance commodity-level video cards [See for example Baskaran & Bordawekar, Research Report RC24704, International Business Machines Corp, April 2009].

All publications, patents and patent applications referenced herein are incorporated by reference in their entirety to the same extent as if each individual publication, patent or patent application was specifically and individually indicated to be incorporated by reference in its entirety.

The following non-limiting examples are illustrative of the present disclosure:

### EXAMPLES

### Example 1

### Custom Peptides and System for Exclusion/Inclusion of Parent Peptides in HPLC-MS/MS Analysis

Custom standard peptides may be used to spike the sample to determine the operating characteristics of the HPLC column and help predict the elution time for peptides that have not eluted from the column. Standard peptides P2-P6 elute under formic acid ion pairing modifier conditions with the following hydrophobicity index (HI; acetonitrile concentration) values:

TABLE 1
Characteristics of standard peptides used for spiking samples

| ID | Sequence | SEQ ID NO: | HI (ACN%) | Time region < HI |
|---|---|---|---|---|
| P2 | LGGGGGGDFR | 1 | 04.58 | R0 |
| P3 | LLGGGGDFR | 2 | 08.55 | R1 |
| P4 | LLLGGDFR | 3 | 13.08 | R2 |
| P5 | LLLLDFR | 4 | 18.26 | R3 |
| P6 | LLLLLDFR | 5 | 21.59 | R4 |

The peptides were designed to uniformly span the typical ACN % values for tryptic peptides. Computer simulations show that under formic acid elution conditions, for a peptide mass range of 800-3200 Daltons, ˜55% of the proteins in the Swissprot Human sequence database contain at least two zero-missed cleavage-peptides that elute in the interval before P2, and ˜85% of the proteins have at least two zero-missed-cleavage peptides that elute in the interval before P3, demonstrating the potential gains from this approach.

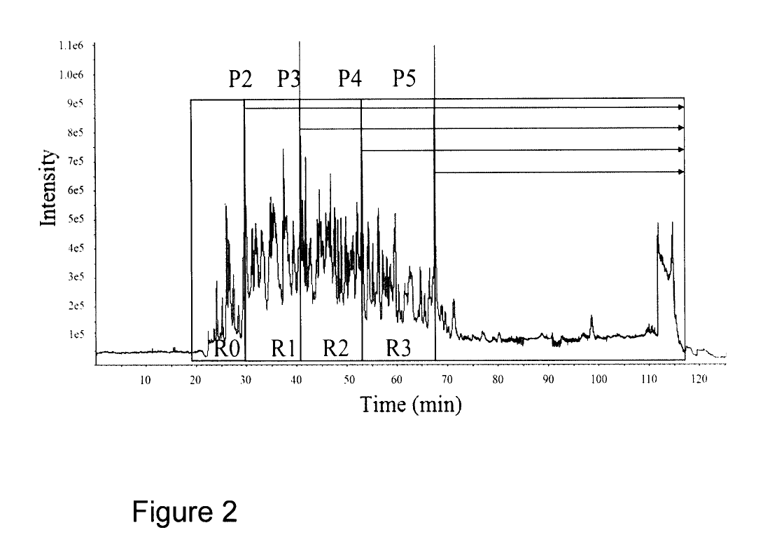

The HPLC component of the experiment can be calibrated off the MS or MS/MS detection of P2-P6 as they elute. At a typical gradient slope of 0.375% per minute, the time interval between these peptides is ˜13 minutes; the computational steps take <5 seconds per cycle, or potentially <1 percent of the total acquisition time. FIG. 2 shows an example of when P2-P6 elute and the corresponding elapsed-time intervals according to the analysis described herein.

As the gradient slope of the HPLC system is known, calibrating between HI and elution time for all peptides initially follows the equation:

T_{P2}=HI_{P2}/(gradient slope)+T₀ (I)

As P3-P6 elute, their retention time values can be used to linearly regress against their HI values, giving more precise values for (gradient slope) and T₀. Retention times and associated values characterizing the chromatography column may also be calculated according to Linear Solvent slope theory, as known in the art and described in Spicer et al. Anal. Chem., 2010, 82 (23), pp 9678-9685, hereby incorporated by reference.

The instrument control software reports the MS/MS spectra as a text file in Mascot Generic Format (MGF) [D. N. Perkins, D. J. C. Pappin, D. M. Creasy, J. S. Cotterell, Electrophoresis 1999, 20(18) 3551-3567]. This file is typically 5-10 megabytes per time-segment. For the time region R0, the instrument has had no exclusion/inclusion list; its MS/MS parent selection is based on MS ion intensity alone. Time regions R1-R4 will benefit from peptide identifications that happen in the previous time region(s) or interval(s).

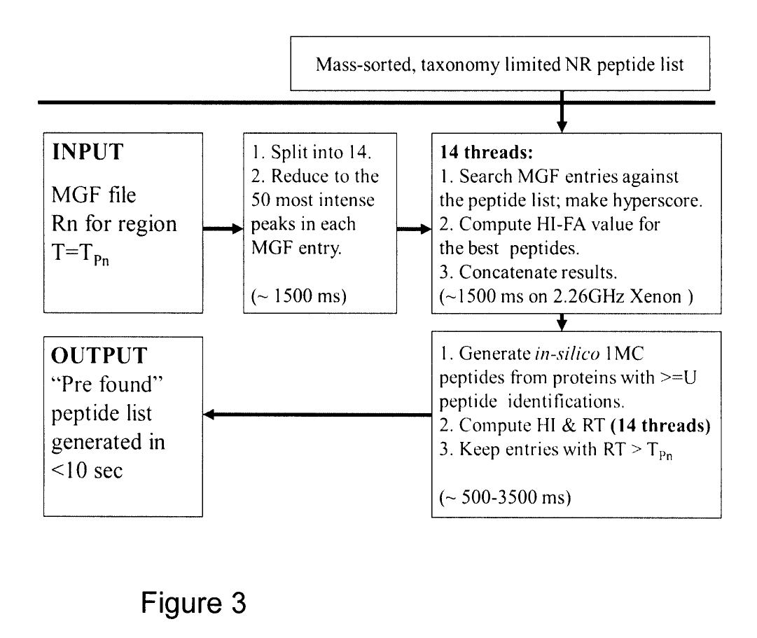

The MGF file is transferred to the exclusion/inclusion engine computer via a network connection. In the CPU-based version of the code, a reduction program splits this file into N equally sized segments, based on the number of processors available (N=14 in the present model). It also reduces the number of fragment ions in each MS/MS spectrum entry to the 50 most intense members, sufficient for this level of identification. FIG. 3 provides an operation flow chart showing the input of the MS/MS spectra data in MGF format, and the output of a “pre found” list of predicted tryptic peptides based on comparisons of the input spectra with a non-redundant (NR) peptide database.

In a system comprising multiple CPUs, each of the N search engines would perform the steps outlined below. Conversely a system comprising a single-CPU (optionally with multiple CPUs) would conduct the following steps on the entire current MGF file.

First, the system loads into memory the common NR peptide database, and creates an index of list positions based on the integer value of the peptide mass. Each database entry contains the peptide's monoisotopic+hydrogen mass, the ascension number of the source protein, and peptide sequence. This NR database is generated before the experiment is conducted. The database used in this example was derived from concatenation of the Swissprot Human and Swissprot Mammals databases. This step benefits from preliminary knowledge of the material in the sample in terms of taxonomy, but this would be typical known for most samples.

Second, the following steps are performed in a loop:
i) Load a MGF entry for the current MS/MS spectrum.
ii) Construct a list of potential peptides based on mass tolerance between the observed parent mass/charge and the hypothetical peptide mass (in our case, 40 PPM).
iii) For each potential peptide sequence, score the presence of b and y ions (both +1 and +2) in the current MS/MS spectrum using a concepts based on the Xltandem hyperscoring algorithm as described in D. Fenyo, R. C. Beavis, Analytical Chemistry 2003 75(4) 768-74, hereby incorporated by reference.
iv) For the highest scoring potential peptide sequence, evaluate its distance from all other candidates and assign an expectation value. If this expectation value is below a preset cutoff the highest scoring peptide sequence is assigned to this mass spectrum.

The system continues to load and identify MGF spectrum entries until the end of the file is reached.

All of the peptide sequences identified in the searches are then submitted to the Sequence-Specific Retention Calculator (SSRCalc) algorithm to compute their HI values (see Spicer et al. Anal Chem. 2007 Nov. 15; 79(22):8762-8; and Krokhin Anal Chem. 2006 Nov. 15; 78(22):7785-95; hereby incorporated by reference). This is done in parallel on the CPU cores (typically 2-16 threads), and the result of these multiple computations are concatenated into single file. Peptides with observed retention times significantly off the postulated retention time Tₚₑₚ=HIₚₑₚ/(gradient slope)+T₀ are excluded from further use; the remainder are appended into the experiment's total peptide list as set out below.

The total peptide list is then loaded into memory. Any protein containing U identified peptides (for this example, U>=2) is considered potentially present in the sample. The protein's sequence is retrieved and in-silico tryptic digestion is conduct (with 1 missed cleavage). The resulting hypothetical associated peptides can also be subjected to post-translational modifications, such as N-terminal cyclization, deamidation and methionine oxidation. The hypothetical tryptic peptide list is then split into N equally sized entries; the HI values for the peptides are computed in parallel across N processing threads, again using SSRCalc. These results are re-assembled into a single file.

The most likely electrospray ion charge state (Z) for each associated peptide is then computed by summing the number of basic amino acids (K, R and H); the m/Z value may be used along with the predicted elution time by the data acquisition software to select parent ions.

Next, the peptide ion parameters (m, Z, retention time, protein and sequence) for entries with retention time greater than T_{Pn} are transferred back to the acquisition computer for use in selecting or excluding subsequent MS/MS parent candidates for CID.

The size of the total peptide list will grow through successive cycles, making the computations of HI values for each peptide identified in the searches and for the hypothetical tryptic peptides potentially the processing bottleneck. The code for generating in-silico single missed cleavage peptides can process over 750 protein sequences per second; if needed this portion of the algorithm could also be made parallel.

### Example 2

### Analysis of a Mixture of Eight Tryptic Proteins

A relatively simple mixture of the following eight tryptically digested human proteins were analyzed using the system and methods described in Example 1: SwissProt protein database accession numbers P02788 (Lactotransferrin), P02787 (Serotransferrin), P02768 (Serum Albumin), P00739 (Haptoglobin related protein), P02671 (Fibrinogen Alpha), P02675 (Fibrinogen Beta), P02679 (Fibrinogen Gamma) and P02751 (Fibrinonectin).

The resulting MGF file from this experiment contained 1291 MS/MS spectra giving 355 non-modified 1-missed-cleavage peptides identified by GPM at a scoring threshold of EV<0. GPM is a suite of software tools for matching tandem (MS/MS) mass spectra with databases of peptide sequences, allowing the identification and validation of proteins as described in R. Graig, J. P. Cortens, R. C. Beavis, Journal of Proteome Research, 2004 3(6) 1234-1242.

At just under 30 minutes peptide P2 eluted. The MGF entries occurring up to and including peptide P2's elution were then submitted to the exclusion/inclusion engine.

Of the 146 MS/MS spectra in the interval R0, the database search gave 21 highly confident peptide sequences belonging to six of the eight known sample proteins based on two or more member peptides as shown in Table 2. The system then predicted 642 potential future peptides belonging to these proteins; 215 of these potential peptides were actually pursued by the instrument during intensity-based parent selection. The CPU version of this operation took ˜2 seconds, while the GPU version on a dual-core AMD-based system took ˜1 second.

If this same sample experiment were to be conducted using the semi real-time acquisition mode, based on the data collected in time region R0 the instrument could have:
A) Maximized protein coverage by pursuing an additional 427 peptides (642 predicted peptides−215 actually pursued) with parents having intensities too low to be subjected to CID in intensity-based acquisition;
OR
B) Excluded at least 215 parent peaks selected by intensity-based acquisition, that were now pre-known to belong to these proteins, gaining instrument time to pursue 215 more interesting peptides.

In addition, the system could also be configured to perform any combination between these two extremes, determined by selection criteria submitted to the control system prior to the start of the experimental run. It should be emphasized that the peptides subsequently identified in R1 (themselves based on the R0 identifications) would then be applied to select the MS/MS spectra collected in R2, etc.

TABLE 2
Data for proteins from the 8-mixture sample found in elution interval
R0 [T = 20 . . . 30 minutes] based on 2 or more member peptides

| m/z + H | z | m + H | theor | PPM | EV | PROT | SEQ (SEQ ID NO) | H-FA | HI | RT |
|---|---|---|---|---|---|---|---|---|---|---|
| 446.716 | 2 | 892.424 | 892.428 | −4 | −8.79 | OLEGCP | LGGGGGGDFR (1) | 17.55 | 6.03 | 29.87 |
| 624.933 | 3 | 1872.783 | 1872.767 | 8 | −18.66 | P02671 | MADEAGSEADHEGTHSTK (6) | 8.77 | 1.68 | 23.42 |
| 462.253 | 2 | 923.497 | 923.495 | 2 | −0.32 | P02671 | TVIGPDGHK (7) | 12.06 | 3.31 | 24.17 |
| 484.218 | 2 | 967.428 | 967.423 | 5 | −1.35 | P02671 | GDFSSANNR (8) | 11.65 | 3.10 | 24.79 |
| 786.850 | 2 | 1572.691 | 1572.678 | 8 | −19.23 | P02671 | GGSTSYGTGSETESPR (9) | 14.12 | 4.33 | 28.17 |
| 482.215 | 2 | 963.423 | 963.420 | 2 | −5.79 | P02679 | DCQDIANK (10) | 10.83 | 2.70 | 24.58 |
| 387.211 | 4 | 1545.820 | 1545.814 | 3 | −0.58 | P02679 | LTIGEGQQHHLGGAK (11) | 14.19 | 4.36 | 29.85 |
| 441.909 | 3 | 1323.711 | 1323.713 | −1 | −10.24 | P02751 | LGVRPSQGGEAPR (12) | 12.04 | 3.30 | 27.48 |
| 467.744 | 2 | 934.480 | 934.478 | 1 | −2.67 | P02751 | ISCTIANR (13) | 14.78 | 4.65 | 29.22 |
| 749.797 | 2 | 1498.586 | 1498.578 | 5 | −17.76 | P02768 | TCVADESAENCDK (14) | 14.07 | 4.30 | 26.38 |
| 518.208 | 3 | 1552.607 | 1552.597 | 6 | −10.71 | P02768 | CCAAADPHECYAK (15) | 10.90 | 2.73 | 26.44 |
| 749.795 | 2 | 1498.582 | 1498.578 | 2 | −20.96 | P02768 | TCVADESAENCDK (14) | 14.07 | 4.30 | 27.51 |
| 435.879 | 3 | 1305.620 | 1305.617 | 2 | −5.93 | P02768 | ECCEKPLLEK (16) | 14.84 | 4.68 | 29.43 |
| 399.187 | 3 | 1195.546 | 1195.543 | 2 | −5.38 | P02787 | WCALSHHER (17) | 13.31 | 3.93 | 25.94 |
| 399.186 | 3 | 1195.542 | 1195.543 | 0 | −3.17 | P02787 | WCALSHHER (17) | 13.31 | 3.93 | 26.97 |
| 439.870 | 3 | 1317.595 | 1317.589 | 4 | −7.23 | P02787 | WCAVSEHEATK (18) | 14.28 | 4.41 | 28.96 |
| 606.610 | 3 | 1817.814 | 1817.804 | 5 | −8.58 | P02787 | EGTCPEAPTDECKPVK (19) | 13.47 | 4.00 | 29.21 |
| 468.277 | 2 | 935.547 | 935.543 | 4 | −11.71 | P02788 | VPSHAVVAR (20) | 8.30 | 1.44 | 23.98 |
| 386.183 | 2 | 771.358 | 771.357 | 0 | −1.81 | P02788 | DCHLAR (21) | 5.86 | 0.23 | 24.06 |
| 532.814 | 2 | 1064.621 | 1064.622 | −1 | −1.51 | P02788 | QVLLHQQAK (22) | 12.01 | 3.28 | 25.40 |
| 429.233 | 2 | 857.457 | 857.455 | 2 | −2.24 | P02788 | GPPVSCIK (23) | 17.32 | 5.91 | 29.30 |

### Example 3

### Analysis of Human Whole Cell Lysate

A sample of human whole-cell lysate (WCL) was analyzed to provide a more atypically complex sample for analysis using the computational exclusion/inclusion of parent ions as described in Example 1. The analysis was performed using a MGF file containing 2086 MS/MS spectra, 1055 of which yield peptides from the GPM search (Global Proteome Machine Organization database; http://www.thegpm.org).

Of the 94 peptides identified by the exclusion/inclusion software in time region R0, 23 of them give 11 future proteins (2 or more peptides each) as shown in Table 3. Of the resulting potential peptides, the instrument pursued 74 of the 557 these in intensity-based acquisition. This number is down significantly from that of Example 2 (74 of 557 vs. 215 of 642) due to the sample complexity; the instrument had high intensity ions from other proteins to pursue.

The 11 proteins postulated from the R0 identifications were present in the GPM results. GPM identified 322 proteins, 206 of which contain 2 or more peptides.

The exclusion/inclusion analysis of the WCL provides for the exclusion of 74 peptides beyond R0, or would allow the instrument to pursue an additional 483 peptides that have parent intensities too low to be pursued under intensity-based acquisition. The system may also be configured to execute parent selection for CID somewhere in between these two extremes.

TABLE 3
Data for proteins from the whole cell lysate (WCL) sample found in
elution interval R0 based on 2 or more member peptides.

| m/z + H | z | m + H | theor | PPM | EV | PROT | SEQ (SEQ ID NO) | H-FA | HI | RT |
|---|---|---|---|---|---|---|---|---|---|---|
| 745.861 | 2 | 1490.715 | 1490.709 | 3 | −9.05 | P04075 | LQSIGTENTEENR (24) | 17.78 | 6.14 | 23.304 |
| 566.788 | 2 | 1132.567 | 1132.578 | −9 | −11.67 | P04075 | ALANSLACQGK (25) | 19.86 | 7.17 | 24.206 |
| 538.747 | 2 | 1076.485 | 1076.476 | 8 | −0.02 | P09382 | DGGAWGTEQR (26) | 18.97 | 6.73 | 23.229 |
| 549.923 | 3 | 1647.752 | 1647.754 | −1 | −2.61 | P09382 | FNAHGDANTIVCNSK (27) | 18.71 | 6.60 | 24.609 |
| 617.303 | 2 | 1233.598 | 1233.596 | 1 | −7.01 | P10809 | VGGTSDVEVNEK (28) | 15.52 | 5.02 | 20.462 |
| 422.76 | 2 | 844.511 | 844.514 | −3 | −2.12 | P10809 | VGEVIVTK (29) | 19.38 | 6.93 | 23.501 |
| 436.555 | 3 | 1307.648 | 1307.653 | −3 | −5.43 | P13639 | NMSVIAHVDHGK (30) | 16.12 | 5.32 | 22.457 |
| 461.732 | 2 | 922.457 | 922.463 | −7 | −0.93 | P13639 | SDPVVSYR (31) | 18.44 | 6.47 | 24.227 |
| 503.75 | 2 | 1006.493 | 1006.496 | −3 | −1.47 | P30740 | EATTNAPFR (32) | 16.69 | 5.60 | 22.726 |
| 482.729 | 2 | 964.45 | 964.452 | −2 | −8.32 | P30740 | ADLSGMSGAR (33) | 18 | 6.25 | 23.36 |
| 533.583 | 3 | 1598.734 | 1598.741 | −4 | −4.43 | P31946 | AVTEQGHELSNEER (34) | 12.83 | 3.69 | 19.539 |
| 591.786 | 2 | 1182.564 | 1182.564 | 0 | −4.62 | P31946 | YLSEVASGDNK (35) | 19.52 | 7.00 | 23.162 |
| 569.29 | 2 | 1137.573 | 1137.572 | 0 | −5.43 | P60174 | IAVAAQNCYK (36) | 17.15 | 5.83 | 23.459 |
| 617.804 | 2 | 1234.6 | 1234.603 | −2 | −12.98 | P60174 | SNVSDAVAQSTR (37) | 15.39 | 4.96 | 23.898 |
| 619.33 | 2 | 1237.652 | 1237.654 | −1 | −8.22 | P62258 | HLIPAANTGESK (38) | 13.63 | 4.08 | 20.482 |
| 459.266 | 2 | 917.523 | 917.531 | −8 | −1.56 | P62258 | IISSIEQK (39) | 19.59 | 7.04 | 22.985 |
| 560.803 | 2 | 1120.597 | 1120.6 | −2 | −5.86 | P68104 | STTTGHLIYK (40) | 15.01 | 4.77 | 21.367 |
| 641.786 | 2 | 1282.565 | 1282.563 | 1 | −0.89 | P68104 | MDSTEPPYSQK (41) | 16.37 | 5.44 | 22.305 |
| 420.227 | 2 | 839.445 | 839.451 | −6 | −0.28 | P68104 | EVSTYIK (42) | 14.44 | 4.48 | 24.147 |
| 514.765 | 2 | 1028.522 | 1028.519 | 3 | −4.94 | Q13885 | TAVCDIPPR (43) | 19.76 | 7.12 | 23.419 |
| 533.22 | 2 | 1065.433 | 1065.428 | 4 | −0.34 | Q13885 | NMMAACDPR (44) | 15.95 | 5.23 | 23.54 |
| 613.334 | 2 | 1225.659 | 1225.665 | −4 | −1.99 | Q14974 | VLANPGNSQVAR (45) | 15.75 | 5.13 | 21.684 |
| 626.991 | 3 | 1878.957 | 1878.942 | 7 | −2.29 | Q14974 | LLETTDRPDGHQNNLR (46) | 17.31 | 5.91 | 23.238 |

### Example 4

### Evaluating Inclusion Based on Mass and Retention Time

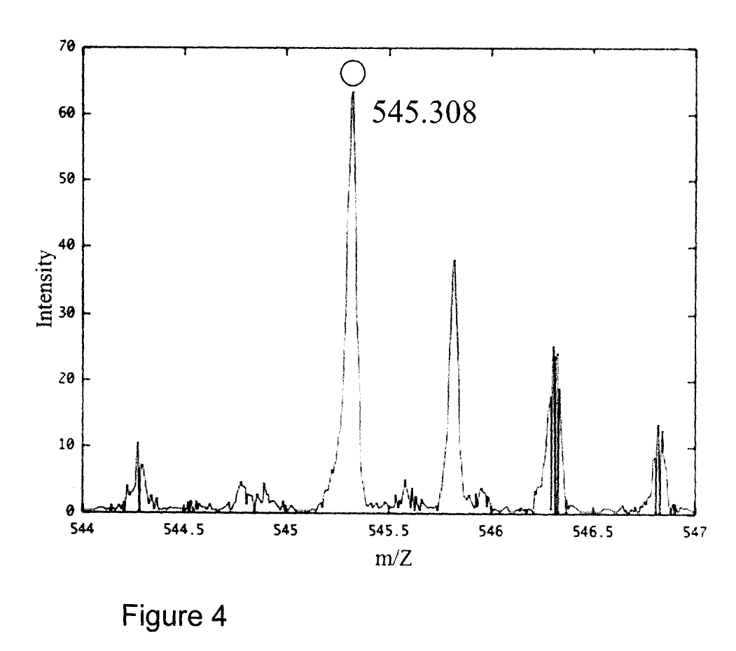

The WCL MS spectra from Example 3 were examined using additional software looking for potential peptide peaks based on predicted mass, charge and retention time. At a signal-to-noise ratio of 5, 40 PPM mass tolerance and +−4 minutes of retention time difference, this search identified 120 peptide peaks from the collection of 557 possible entries (one example is shown in FIG. 4). This resulted in a gain of 46 possible peptides beyond elution interval R0 compared to intensity-based acquisition. MS/MS confirmation on these peaks has not been performed at this point, so the identity of these peptides may not be what is postulated.

This suggests that while the presence of forward-predicted peaks in the MS spectrum is perhaps ˜20% of those postulated, the inclusion approach has the potential to intelligently see deeper into a complex sample and improve peptide coverage.

But given the low intensity of many of these peaks (on average about half of the intensity of those selected the intensity-based method) further work is needed to see if they could yield useful MS/MS spectra within a reasonable amount of acquisition time.

### Example 5

### Performance of the Peptide Identification Algorithm

838 peptides with elution times less than 55 minutes (end of R3) were identified for the WCL sample. The total time to execute four cycles of identification and prediction computations was ˜17 seconds on the CPU version, and ˜10 seconds using the GPU version.

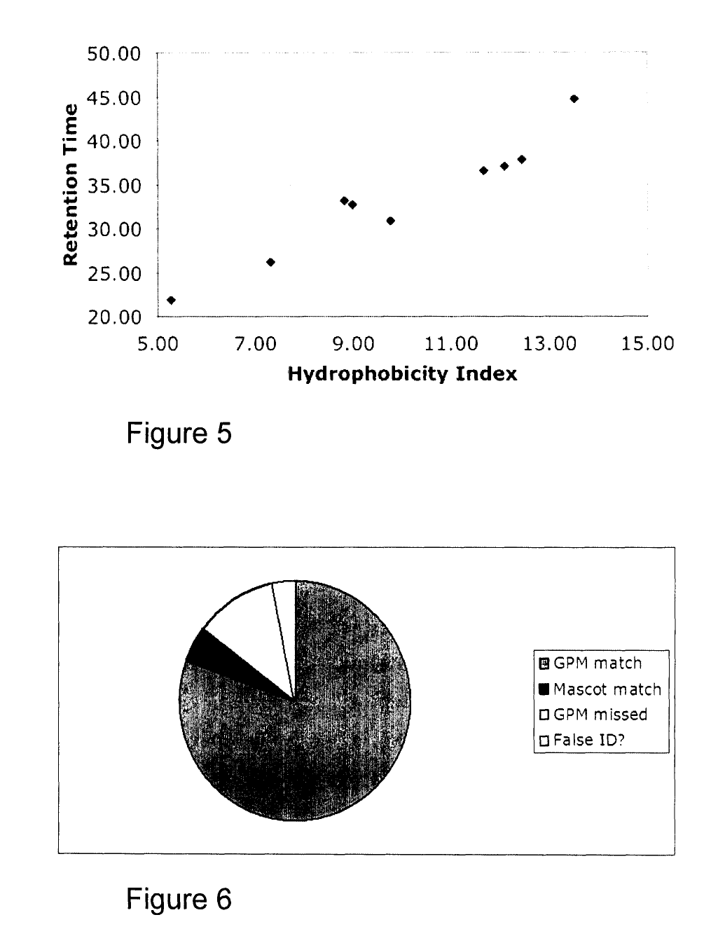

GPM identified 947 peptides; 763 of these match our results (a ˜80% overlap). Of potential false-positives (peptides that GPM did not identify), all but nine of them are singlets within their proteins. The nine peptides potentially generate four false-predicted proteins as shown in Table 4. Given the linear nature of the HI-RT plot for these sequences shown in FIG. 5, the underlying mechanism that could be responsible for this result were investigated.

These peptide assignments are from MS/MS spectra that GPM did not assign peptide sequences to, indicating the simplified scoring algorithm is not only less adept at identifying peptides than GPM, but is also assigning peptides to spectra that GPM rejects. The spectra were submitted to Mascot's MS/MS identification tool [D. N. Perkins, D. J. C. Pappin, D. M. Creasy, J. S. Cotterell, Electrophoresis 1999, 20(18) 3551-3567], which confirmed the 9 peptide sequences. The 75 unmatched MS/MS entries were then submitted and Mascot confirmed 44 of the 75 sequences proposed by our algorithm as shown in FIG. 6. These observations indicate that the peptide identification algorithm is sufficiently robust to deal with complex samples.

TABLE 4
Whole cell lysate (WCL) sample identified peptides not seen in the
GPM results, suggesting four false predicted proteins. These peptides were
later confirmed using the Mascot MS/MS spectrum analysis software.

| m/z + H | z | m + H | theor | PPM | EV | PROT | SEQ (SEQ ID NO) | H-FA | HI | RT |
|---|---|---|---|---|---|---|---|---|---|---|
| 457.291 | 2 | 913.575 | 913.583 | −9 | −6.08 | P00338 | LVIITAGAR (47) | 23.52 | 8.98 | 32.76 |
| 465.292 | 2 | 929.575 | 929.582 | −7 | −2.69 | P00338 | FIIPNVVK (48) | 32.66 | 13.51 | 44.72 |
| 758.876 | 2 | 1516.743 | 1516.750 | −4 | −2.37 | P06493 | LESEEEGVPSTAIR (49) | 25.08 | 9.76 | 30.95 |
| 593.310 | 2 | 1185.611 | 1185.616 | −3 | −2.62 | P06493 | IGEGTYGVVYK (50) | 23.18 | 8.81 | 33.19 |
| 577.810 | 2 | 1154.611 | 1154.617 | −4 | −2.28 | P12763 | HTLNQIDSVK (51) | 16.04 | 5.28 | 21.89 |
| 659.986 | 3 | 1977.941 | 1977.945 | −1 | −7.39 | P12763 | QQTQHAVEGDCDIHVLK (52) | 20.14 | 7.31 | 26.22 |
| 737.910 | 2 | 1474.812 | 1474.838 | −17 | −16.12 | P12763 | TPIVGQPSIPGGPVR (53) | 30.49 | 12.44 | 37.87 |
| 729.370 | 2 | 1457.732 | 1457.739 | −4 | −4.78 | P30486 | WTAVVVPSGEEQR (54) | 28.93 | 11.66 | 36.59 |
| 753.366 | 2 | 1505.725 | 1505.735 | −6 | −6.72 | P30486 | SWTAADTAAQISQR (55) | 29.78 | 12.08 | 37.08 |

While the above description includes a number of exemplary embodiments, many modifications, substitutions, changes, and equivalents will now occur to those of ordinary skill in the art. It is, therefore, to be understood that the appended claims are intended to cover all such modifications and changes.

All publications, patents and patent applications are herein incorporated by reference in their entirety to the same extent as if each individual publication, patent or patent application was specifically and individually indicated to be incorporated by reference in its entirety.

What is claimed is:

1. A method of analyzing a sample using chromatography and tandem mass spectrometry, the method comprising:
a) providing a sample comprising one or more sample peptides,
b) adding one or more standard peptides to the sample to form a test sample, wherein an amino acid sequence and hydrophobicity index for each standard peptide is known,
c) introducing the test sample into a chromatography column and eluting a test sample stream from the chromatography column into a tandem mass spectrometer,
d) acquiring first time interval mass spectra and associated retention times for a plurality of peptides contained in the test sample stream during a first time interval, wherein the test sample stream during the first time interval comprises at least one standard peptide,
e) comparing the first time interval mass spectra to a mass spectra reference database to form a set of identified sample peptide sequences based on sample peptides contained in the sample stream during the first time interval,
f) for at least one identified sample peptide sequence, searching a protein sequence reference database to identify and retrieve one or more protein sequences that contain the identified sample peptide sequence,
g) generating a set of associated peptide sequences by analyzing the one or more protein sequences retrieved in sequences, wherein the identified sample peptide sequence and the associated peptide sequence differ and are both contained within the protein sequence,
h) determining a predicted retention time for at least one associated peptide sequence based on the retention time for one or more standard peptides acquired in step d), and
i) acquiring second time interval mass spectra and associated retention times for the test sample stream during a second time interval by configuring the tandem mass spectrometer to transmit some ions and filter out other ions based on the at least one associated peptide sequence in the set of associated peptide sequences and the predicted retention time determined in step h).

2. The method of claim 1, wherein the mass spectrometer comprises a mass analyzer and a detector and step i) further comprises configuring the mass analyzer to transmit an ion or secondary ion of the at least one associated peptide sequence to the detector.

3. The method of claim 1, wherein the mass spectrometer comprises a mass analyzer and a detector and step i) further comprises configuring the mass analyzer to impede the transmission of an ion or secondary ion of the at least one associated peptide sequence to the detector.

4. The method of claim 1, wherein step i) comprises selecting or excluding an associated peptide sequence contained in the set of associated peptide sequences as a parent ion for dissociation into secondary ions.

5. The method of claim 1, wherein a plurality of standard peptides are added to the sample to form the test sample and the predicted retention time for the at least one associated peptide sequence is determined based on a plurality of retention times for the plurality of standard peptides acquired in step d).

6. The method of claim 1, wherein step h) comprises calculating a hydrophobicity index (HI) for the at least one associated peptide sequence and the retention time for the at least one associated peptide sequence is calculated based on the hydrophobicity index of the associated peptide sequence and the retention time and hydrophobicity index of the one or more standard peptides.

7. The method of claim 6, wherein the hydrophobicity index for each associated peptide sequence is calculated using SSRCalc.

8. The method of claim 6, wherein the retention times are calculated according to the equation:
T_{P}=HI_{P}/(gradient slope)+T₀
wherein T_{P} is the retention time for the associated peptide sequence, HI_{P} is the hydrophobicity index for the associated peptide sequence, and T₀ is calculated based on an observed retention time of the one or more standard peptides.

9. The method of claim 1 further comprising calculating a mass (m) and/or electrospray ion charge state (Z) for each of the one or more associated peptide sequences determined in step h), and step i) further comprises configuring the tandem mass spectrometer to transmit some ions and filter out other ions based on the mass and/or electrospray charge state of at least one associated peptide sequence in the set of associated peptide sequences.

10. The method of claim 9, wherein the electrospray ion charge state (Z) for each associated peptide sequence is calculated by summing the number of basic amino acids in the associated peptide sequence.

11. The method of claim 10, wherein the basic amino acids are lysine, arginine and histidine.

12. The method of claim 1, wherein during the first time interval mass spectra are acquired by selecting parent ions for dissociation into secondary ions based on an observed intensity of the parent ions.

13. The method of claim 1, wherein the sample peptides are tryptic peptides and step g) comprises analyzing the protein sequence to identify associated peptide sequences that represent tryptic peptides.

14. The method of claim 13, wherein the tryptic peptides have 0, 1, 2 or 3 missed tryptic cleavages.

15. The method of claim 1, wherein the step g) further comprises identifying associated peptide sequences that contain one or more post-translational modifications.

16. The method of claim 15, wherein the one or more post-translation modifications comprise N-terminal cyclization, deamidation or methionine oxidation.

17. The method of claim 1, wherein the standard peptides comprise one or more peptides selected from the group consisting of LGGGGGGDFR, LLGGGGDFR, LLLGGDFR, LLLLDFR, and LLLLLDFR.

18. A computerized control system for controlling and receiving data from a tandem mass spectrometer, the computerized control system comprising at least one processor and memory configured to provide:
a) a control and communications module for receiving data from the tandem mass spectrometer, the data comprising a first set of mass spectra and associated retention times collected during a first time interval for a sample stream comprising one or more sample peptides and one or more standard peptides, wherein an amino acid sequence and hydrophobicity index for each standard peptide is known;
b) a search module for:
i) identifying amino acid sequences for the one or more sample peptides contained in the sample stream by comparing the first set of mass spectra to a mass spectra reference database to form a set of identified sample peptide sequences, and
ii) for at least one identified sample peptide sequence, search a protein sequence reference database to identify and retrieve one or more protein sequences that contain the identified sample peptide sequence;
c) an analysis module for receiving the one or more protein sequences identified by the search module and generating a set of associated peptide sequences by analyzing the one or more protein sequences to identify one or more associated peptide sequences, wherein the identified sample peptide sequence and the associated peptide sequence are both contained within the protein sequence and the analysis module being further operable to determine a predicted retention time for at least one associated peptide sequence based on the retention times for the one or more standard peptides; and
wherein the control and communications module is further operable to communicate with and configure the tandem mass spectrometer to transmit some ions and filter out other ions based on at least one associated peptide sequence in the set of associated peptide sequences and the predicted retention time.

19. The system of claim 18, wherein the control and communications module is further operable to communicate with and configure the tandem mass spectrometer to select or exclude one or more associated peptides contained in the set of associated peptide sequences as parent ions for dissociation into secondary ions.

20. The system of claim 18, wherein the computerized control system further comprises a user interface operable to receive one or more selection criteria, wherein the processor is further operable to configure the analysis module to include associated peptide sequences in the set of associated peptide sequences based on the criteria received in the user interface.

21. The system of claim 18, wherein the analysis module is further operable to determine the predicted retention time for at least one associated peptide sequence based on the retention times for a plurality of standard peptides.

22. The system of claim 18, further comprising a tandem mass spectrometer comprising a first mass analyzer operable to select a parent ion, a collision cell operable to dissociate a parent ion to produce one or more secondary ions, a second mass analyzer operable to select a secondary ion, and a detector.

23. The system of claim 22, further comprising a chromatography column, wherein the tandem mass spectrometer is adapted to receive the sample stream comprising one or more sample peptides from the chromatography column.
